(19) United States
(12) Patent Application Publication
(10) Pub. No.: US 2008/0162237 A1
(43) Pub. Date: Jul. 3, 2008

(54) Apparatus, method and computer program product providing challenge and proposal type calendar events for review, modification and approval

(75) Inventors: Jussi Hurmola, Tampere (FI); Sampo J. Savolainen, Espoo (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/646,766

(22) Filed: Dec. 28, 2006

(51) Int. Cl. G06F 9/46

(52) U.S. Cl. 705/8

(57) ABSTRACT

A method includes sending a proposed event from an originating calendar application to a recipient calendar application, and one of replying with an approval of the proposed event or a modification to the proposed event from the recipient calendar application to the originating calendar application. Also disclosed are computer program products and devices that include calendar application(s) that operate as in the method.

### TECHNICAL FIELD

The exemplary embodiments of this invention relate generally to user interfaces for devices and methods pertaining to same and, more specifically, relate to calendar-type and similar scheduling-capable and time management applications.

### BACKGROUND

An automated calendar application is typically used in a manner similar to that of a traditional list of reminders written into a book or other paper medium. Decision making and simple tasks are all manually determined and added to the calendar. The calendar is based on singleton events which are communicated through some invitation-type of explanation of an event content and time of occurrence.

Time is a resource that everyone understands and has access to. In the modern information community the amount of data can easily swamp an individual, hindering the individual's work performance and enjoyment of personal life. Information arranging systems have traditionally concerned mostly the information external to the person. However, in the information era one's personal information, and the management of that personal information, becomes an important factor in a person's effectiveness and independence. A personal resource that is often underrated or totally overlooked is Time.

As is noted by A. Niemi (Nokia Research Center) in Internet-Draft: Session Initiation Protocol Event Packages for Calendering, draft-niemi-sipping-cal-events-01, expired Sep. 7, 2006, calendar sharing enables a user to subscribe to receiving information of a specific remote calendar. This calendar can represent the calendar entries of a particular user's daily schedule, or any other type of calendar information such as the release schedule of an open source software project.

Niemi discusses several preexisting standards, and works in progress, in the area of calendaring. Most notably, the Internet Scheduling Core Object Specification (iCalendar), (see Dawson, F. and Stenerson, D., “Internet Calendaring and Scheduling Core Object Specification (iCalendar)”, RFC 2445, November 1998), the iCalendar Transport-Independent Interoperability Protocol (iTIP), (see Silverberg, S., Mansour, S., Dawson, F., and R. Hopson, “iCalendar Transport-Independent Interoperability Protocol (iTIP) Scheduling Events, BusyTime, To-dos and Journal Entries”, RFC 2446, November 1998), define the data format, and its binding to Internet email (see Dawson, F., Mansour, S., and S. Silverberg, “iCalendar Message-Based Interoperability Protocol (iMIP)”, RFC 2447, November 1998).

RFC 3265 (Roach, A., “Session Initiation Protocol (SIP)-Specific Event Notification”, June 2002) defines an event subscription and notification framework that can be used to subscribe to different types of events related to SIP systems. A publication counterpart, defined in RFC 3903 (Niemi, A., “Session Initiation Protocol (SIP) Extension for Event State Publication”, RFC 3903, October 2004), allows for a SIP user agent to publish event state into a central compositor that then distributes this information to the subscribers of that event package.

The Niemi Internet draft (draft-niemi-sipping-cal-events-01) defines two new event packages for calendaring events; the first allows sharing of calendar events and the second enables scheduling events related to calendaring. Using these two event packages there is defined, in effect, an iTIP mapping to SIP.

Niemi defines several related concepts as follows: Calendar User Agent: a SIP user agent that acts on the behalf of the calendar user, Calendar Server: a SIP user agent responsible for accepting subscriptions and sending out notifications containing calendar data, Calendar Watcher: a SIP user agent responsible for issuing subscriptions and processing notifications of calendar events.

The background of calendar sharing and scheduling applications as summarized by Niemi as dating back several years. Especially in the enterprise domain, these applications have been commonplace for nearly a decade. Many enterprise collaboration tools have provided enterprise users with tools that enable calendar access, as well as the ability to schedule meetings and other calendar entries among the users.

Tools based on proprietary protocols have provided very little interoperability, and generally have not allowed inter-organizational calendar access. Being able to schedule meetings across organizations necessitates the availability of: interoperable data formats, interoperable sharing and scheduling protocols and reasonable means of access control and channel security.

The availability of the first is all but guaranteed at present. The iCalendar format and its predecessor, the vCalendar format (see Internet Mail Consortium, “vCalendar—The Electronic Calendaring and Scheduling Exchange Format”, http://www.imc.org/pdi/vcal-10.txt, September 1996) are nearly ubiquitous and supported currently by a majority of Personal Information Management (PIM) applications.

Some solutions for calendar sharing and scheduling have been available based on standard components, such as by being based on HTTP (see Fielding, R., Gettys, J., Mogul, J., Frystyk, H., Masinter, L., Leach, P., and T. Berners-Lee, “Hypertext Transfer Protocol—HTTP/1.1”, RFC 2616, June 1999) and WebDAV (see Goland, Y., Whitehead, E., Faizi, A., Carter, S., and D. Jensen, “HTTP Extensions for Distributed Authoring—WEBDAV”, RFC 2518, February 1999) extensions. Recent efforts have proposed CalDAV as a standard calendar access protocol based on WebDAV. Extending calendaring applications beyond a single administrative domain requires that the protocols allow reasonable means for user identification, authentication and access control.

However, there are deficiencies in the various currently available calendar-related and scheduling-related applications. For example, assume that a person wants to propose a training schedule, or a travel agency wants to display a package holiday. Currently there is no way for the proposing party to synchronize an event or a series of events to a user's calendar for review and/or modification by the user.

The above-reference Niemi approach may suggest that there be more that one calendar per user, which may be problematic from a time management standpoint.

### SUMMARY OF THE EXEMPLARY EMBODIMENTS

The foregoing and other problems are overcome, and other advantages are realized, in accordance with the non-limiting and exemplary embodiments of this invention.

In accordance with the exemplary embodiments of this invention there is provided a method that includes sending a proposed event from an originating calendar application to a recipient calendar application, and one of replying with an approval of the proposed event or a modification to the proposed event from the recipient calendar application to the originating calendar application.

Further in accordance with the exemplary embodiments of this invention there is provided a computer program product that comprises computer executable program instructions embodied in a tangible storage medium, the execution of the instructions resulting in operations that comprise sending a proposed event from an originating calendar application to a recipient calendar application, and receiving a reply comprising an approval of the proposed event or a modification to the proposed event from the recipient calendar application.

Further in accordance with the exemplary embodiments of this invention there is provided a computer program product that comprises computer executable program instructions embodied in a tangible storage medium, the execution of the instructions resulting in operations that comprise receiving with a recipient calendar application a proposed event from an originating calendar application, and sending a reply comprising an approval of the proposed event or a modification to the proposed event to the originating calendar application.

Further in accordance with the exemplary embodiments of this invention there is provided a device having a user interface coupled to a first calendar application configured to send a proposed event to a second calendar application, and further configured to respond to a reply to the proposed event from the second calendar application, where the reply comprises one of an approval of the proposed event or a modification to the proposed event.

In accordance with yet another exemplary embodiment of this invention there is provided a device having a user interface coupled to a first calendar application configured to receive a proposed event from a second calendar application, and further configured to send a reply to the proposed event to the second calendar application, where the reply comprises one of an approval of the proposed event or a modification to the proposed event.

### BRIEF DESCRIPTION OF THE DRAWINGS

The foregoing and other aspects of the teachings of this invention are made more evident in the following Detailed Description, when read in conjunction with the attached Drawing Figures, wherein:

FIG. 1 is a simplified block diagram an embodiment of a wireless communications device suitable for practicing the exemplary embodiments of this invention;

FIG. 2 is a block diagram showing an originating calendar application and a recipient calendar application, and the message flow between them that is suitable for use in implementing the exemplary embodiments of this invention; and

FIG. 3 is a logic flow diagram that is illustrative of a method, and the operation of computer program products, for practicing the exemplary embodiments of this invention.

### DETAILED DESCRIPTION

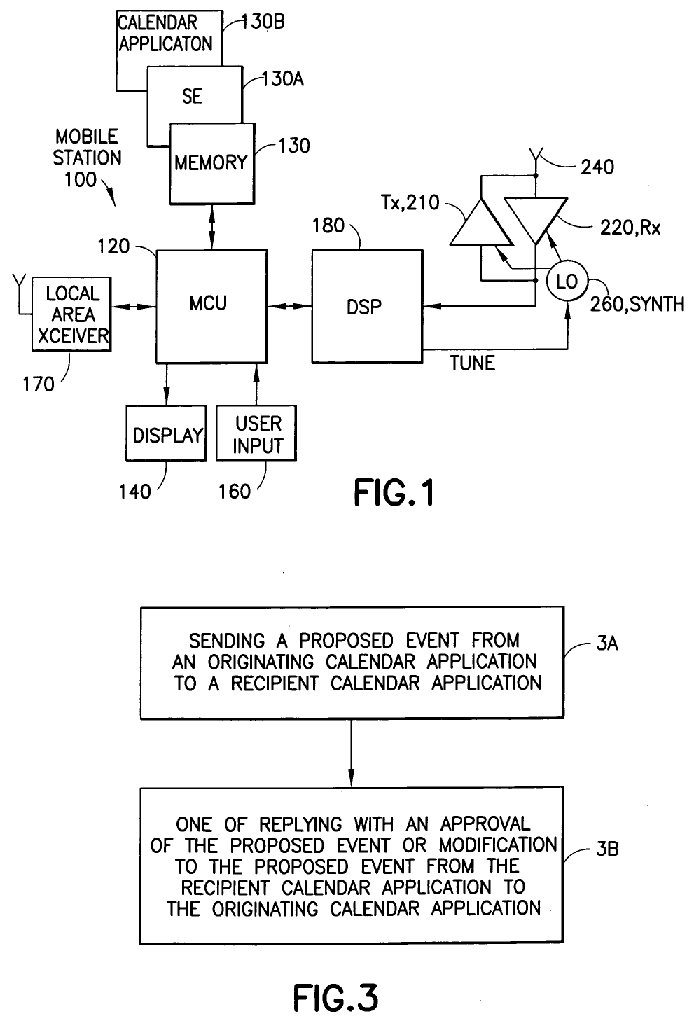

Referring to FIG. 1 there is shown as a simplified block diagram an embodiment of a device, such as a wireless communications device or mobile station 100, that is suitable for practicing the exemplary embodiments of this invention.

It should first be noted that while the exemplary embodiments of the invention will be shown and described as being practiced in a device such as wireless communications terminal, in general the teachings of this invention apply to any type of electronic device that is capable of hosting a calendar/scheduling application software. Thus, the exemplary embodiments of this invention may be used in desktop computers and workstations, laptop computers, notebook computers and personal digital assistants (PDAs), to name just a few of the many possible devices that can benefit from the use of the exemplary embodiments of this invention. As such, it should be appreciated that the description of the mobile station (MS) 100 in FIG. 1 is not intended to be read in any way as a limitation upon the use and possible implementations of the exemplary embodiments of this invention.

Still referring to FIG. 1, the mobile station 100 typically includes a control unit or control logic, such as a microcontrol unit (MCU) 120, having an output coupled to an input of a display 140 and an input coupled to an output of a user input 160, such as a real or virtual keyboard or keypad and that may include some type of pointing device such as, but not limited to, a stylus, a mouse or a touch-sensitive display screen. The mobile station 100 may be a handheld radiotelephone, such as a cellular telephone or a personal communicator. The mobile station 100 could also be contained within a card or module that is connected during use to another device. For example, the mobile station 10 could be contained within a PCMCIA or similar type of card or module that is installed during use within a portable data processor, such as a laptop or notebook computer.

In general, the various embodiments of the MS 100 can include, but are not limited to, cellular phones, personal digital assistants (PDAs) and portable computers, and may include or incorporate, as non-limiting examples, image capture devices such as digital cameras, gaming devices, music storage and playback appliances, Internet appliances permitting Internet access and browsing, as well as units or terminals that incorporate combinations of such functions.

The MCU 120 is assumed to include or be coupled to some type of a memory 130, including a non-volatile memory for storing an operating program and other information, as well as a volatile memory for temporarily storing required data, scratchpad memory, received data, data to be transmitted, and the like. The operating program is assumed, for the purposes of this invention, to enable the MCU 120 to execute the software routines, layers and protocols required to implement the methods in accordance with the exemplary embodiments of this invention, as well as to provide a suitable user interface (UI), via display 140 and user input 160, with a user. Although not shown, a microphone and speaker may be provided for enabling the user to conduct voice calls in a conventional manner.

Stored in the memory 130 is assumed to be a data structure that is descriptive of at least one scheduled event (SE) 130A, such as meetings. The SE data structure 130A is established, managed and used in accordance with the exemplary embodiments of this invention. Associated with the SE 130A is a scheduled event application, which may be referred to for convenience as a calendar application 130B. The calendar application 130B comprises computer executable program code that interacts with the data structure that is descriptive of the SE 130A, and is suitable for use in implementing the exemplary embodiments of this invention, as described more fully below.

The mobile station 100 also typically contains a wireless section that includes a digital signal processor (DSP) 180, or equivalent high speed processor or logic, as well as a wireless transceiver that includes a transmitter 200 and a receiver 220, both of which are coupled to at least one antenna 240 for communication with a network operator. At least one local oscillator, such as a frequency synthesizer (SYNTH) 260, is provided for tuning the transceiver. Data, such as digitized voice and packet data, is transmitted and received through the antenna 240. The wireless section may be considered to function as a long range interface (e.g., hundreds or thousands of meters) to a base station coupled to a communications network, such as a cellular operator network and/or the Internet. Note that the MS may also include a local area wireless transceiver (Xceiver) 170, such as one based on Bluetooth™ low power RF or infrared (IR) technology. The local area transceiver 170 may be considered as a short range interface (e.g., meters or tens of meters) for coupling to a wireless local area network (WLAN) via a suitable access point.

The exemplary embodiments of this invention may be implemented by computer software (e.g., the calendar application 130B) executable by a data processor of the mobile station 100, such as the processor 120, or by hardware, or by a combination of software and hardware. Further in this regard it should be noted that the various blocks of the logic flow diagram of FIG. 3 (described below) may represent program steps, or interconnected logic circuits, blocks and functions, or a combination of program steps and logic circuits, blocks and functions.

The memory 130 may be of any type suitable to the local technical environment and may be implemented using any suitable data storage technology, such as semiconductor-based memory devices, magnetic memory devices and systems, optical memory devices and systems, fixed memory and removable memory. The data processor(s) 120, 180 may be of any type suitable to the local technical environment, and may include one or more of general purpose computers, special purpose computers, microprocessors, digital signal processors (DSPs) and processors based on a multi-core processor architecture, as non-limiting examples.

In general, the various exemplary embodiments may be implemented in hardware or special purpose circuits, software, logic or any combination thereof. For example, some aspects of the exemplary embodiments of this invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

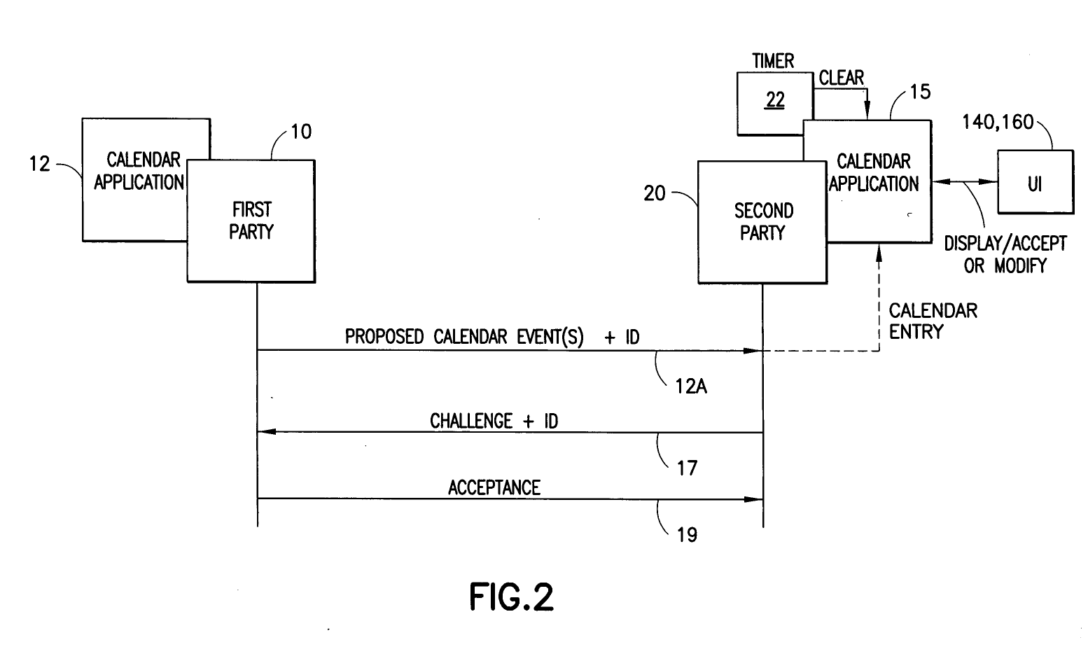

In accordance with exemplary embodiments of this invention, and referring also to FIG. 2, there is provided a technique to provide a proposed state of calendar event for a user's review, possible modification and reply. A first party 10 sends from a first calendar application 12 a proposed calendar event or series of proposed calendar events 12A to a second calendar application 15 of a second party 20. In this case the first calendar application 12, which may be referred to as an originating calendar application, may be the calendar application 130B associated with the mobile station 100 of FIG. 1, or it may be associated with a computer, such as a PC, or with any other type of device capable of hosting a calendar application, including a PDA or similar type of device. The second calendar application 15, which may be referred to as a recipient calendar application, may be the calendar application 130B associated with the mobile station 100 of FIG. 1, or it may be associated with a computer, such as a PC, or with any other type of device capable of hosting a calendar application, including a PDA or similar type of device. Both of the calendar applications 12 and 15 may be associated with mobile devices, or they may both be associated with non-mobile devices. In general, a proposed calendar event may be sent through a wireless link (radio frequency or optical), or it may be sent through a wired link, either of which may use the internet protocol or any other suitable data communication protocol, such as local area network (LAN) protocol. The wireless link may be conveyed through the long range transceiver 210, 220 via a base station and a network operator, or through the short range transceiver 170 via a local area access point.

In response to receiving the proposed event a resulting calendar entry is made by the second calendar application 15, and this calendar entry is displayed in a visually distinct manner by using color or some other suitable means. The user associated with second calendar application 15 (the second party 20 in this example) can review the displayed calendar event. The user associated with second calendar application 15 (the second party 20 in this example) may or may not modify the event, and replies to the event by accepting or rejecting it. For a case where the user associated with second calendar application 15 (the second party 20 in this example) modifies the event and then accepts the modified event, the calendar application 15 sends a challenge 17 to the first party 10 associated with the first calendar application 12 for approval. If the first party 10 accepts (e.g., ACKs) the modified event (such as by sending an acknowledgment message 19) the event is synchronized to both calendar applications 12 and 15.

It is within the scope of the exemplary embodiments of this invention to provide a cancellation timer 22 which upon expiration clears the event from the recipient's calendar 15 and notifies the user.

The utility of the exemplary embodiments of this invention can be appreciated from several non-limiting examples. As a first example, assume a travel agency that sells package tours and that negotiates prices and schedules with the user. All reviewing and schedule modification can be performed using the calendar applications 12 and 15, which are synchronized at the end of the transaction. As a second example, assume a training center that sends a proposal of a month long course with some arbitrary number of lessons. The receiving user is enabled to interact with his calendar application 15 to modify displayed events to suit his needs, and then accept the modified event. The originating training center can then review the changes and accept or reject the modified schedule of events (e.g., the modified course schedule). If the originator (the training center in this case) rejects a modified event then the entire schedule may be cancelled, or just the modified event(s) may be cancelled, or the training center may reply with another modification to the event for review and approval by the recipient (the user associated with the calendar application 15). In this manner there may be multiple proposed event and response iterations until both parties either reject or accept each proposed calendar event.

In accordance with the exemplary embodiments of this invention the calendar application 130B of FIG. 1 (also shown as the calendar applications 12 and 15 in FIG. 2) enables the use of a proposal state for calendar events.

A unique identification (ID) may be assigned to a proposed event when it is first sent for enabling a modification or acceptance reply to be subsequently associated with the proposed event. A proposed calendar event can be visually distinguished from other calendar events by color or in some other visually distinct manner. The calendar application 130B may also sort proposed calendar events and enable them to be displayed and viewed in isolation from other calendar events. A calendar “handshake” indicates that the event is a proposed event, and the recipients calendar application (the application 15 in FIG. 2) permits modification of the proposed event (e.g., by enabling the use to change a start time, and/or an end time, and/or a date or dates on which the event is to occur). When the user approves a modified proposed event, the approval is sent as a proposed event back to the originating calendar application 12, which treats the received proposed event as a common proposed event (as opposed to a new proposed event). The originator's calendar application 12 matches the returned proposed event ID to the proposed event IDs previously sent. If the ID matches, the originator's calendar application 12 replaces the original proposed event with the approved event, thereby synchronizing the calendar application 12 of the originator with the calendar application 15 of the recipient. Modifying the new event and sending it back as a new proposed event deletes the originally proposed calendar event.

It is within the scope of the exemplary embodiments for the recipient to send back a proposed calendar event, with the associated ID, in an unmodified form to signal acceptance, or a predefined signaling word/command can be used to signal acceptance.

Referring to FIG. 3, a method in accordance with the exemplary embodiments of this invention includes, at Block 3A, sending a proposed event from an originating calendar application to a recipient calendar application and, at Block 3B, one of replying with an approval of the proposed event or a modification to the proposed event from the recipient calendar application to the originating calendar application.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate. Programs automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting embodiments a full and informative description of the invention. However, various modifications and adaptations may become apparent to those skilled in the relevant arts in view of the foregoing description, when read in conjunction with the accompanying drawings and the appended claims.

For example, while described above in at least one non-limiting example as the Calendar Application 130B displaying calendar-related information on the display 140, in other embodiments a remote display could be used, i.e., the calendar application and display need not be co-located in the same device or unit. Also, it should be realized that the exemplary embodiments of this invention can be used with any type of scheduled event, including meetings, concerts, dinner engagements and the like.

Further, it is within the scope the exemplary embodiments to provide a filter at the input to the recipient calendar application 15 to enable the selective reception of proposed calendar events from only approved/authorized originating calendar application(s) 12.

Further, it is also within the scope the exemplary embodiments to provide an ability to send a text or other type of message with a proposed calendar event. For example, assume the originator sends a proposed calendar event for 15 May: “dinner at 18:30”, and with the proposed calendar event an associated text message: “if not acceptable I am available also on 17 and 18 May”, thereby providing the recipient with some guidance as to making a proposed modification to the proposed calendar event. The optional message may be displayed in association with a displayed proposed calendar event, but need not form a part of the displayed calendar event per se.

In addition, it is pointed out that while the exemplary embodiments of this invention have been primarily disclosed in the context of a mobile device (e.g., the MS 100), such as a mobile communication device, the exemplary embodiments may be employed as well in, as non-limiting examples, PC-based and web-based calendar applications. For example, a PC may initiate (or terminate) a mobile phone call (or an IP call, such as a VoIP call) on behalf of a user. That is, all of the exemplary embodiments described above may be embodied in any of a number of device types and systems, and are not intended to be limited in any way to any specific type of device or system.

Thus, all such and similar modifications to the exemplary embodiments of this invention will still fall within the scope of the invention.

Furthermore, some of the features of the examples of this invention may be used to advantage without the corresponding use of other features. As such, the foregoing description should be considered as merely illustrative of the principles, teachings, examples and exemplary embodiments of this invention, and not in limitation thereof.

What is claimed is:

1. A method, comprising:
sending a proposed event from an originating calendar application to a recipient calendar application; and
one of replying with an approval of the proposed event or a modification to the proposed event from the recipient calendar application to the originating calendar application.

2. The method of claim 1, where sending the proposed event includes sending an identification associated with the proposed event, and where replying includes sending the identification back to the originating calendar application.

3. The method of claim 1, where the modification to the proposed event comprises at least one of changing a start time, an end time and a date on which the proposed event is to at least one of start or end.

4. The method of claim 1, where in response to receiving a modification to the proposed event at the originating application, further comprising treating the received modification to the proposed event as a common proposed event, and one of approving the proposed common event or proposing a modification to the common proposed event.

5. The method of claim 1, where at least one of the originating calendar application and the recipient calendar application are resident in a mobile device, and where communication between the originating and recipient calendar applications occurs at least in part through a wireless link.

6. The method of claim 1, where at least one of the originating calendar application and the recipient calendar application are resident in a mobile communication device, and where communication between the originating and recipient calendar applications occurs at least in part through one of a short range wireless link and a long range wireless link.

7. The method of claim 1, where a received proposed event is display to a user of the recipient calendar application in a manner that is visually distinct from other displayed calendar events.

8. The method of claim 1, further comprising sorting proposed calendar events and displaying proposed calendar events in isolation from other calendar events.

9. The method of claim 1, where a result of approving a proposed calendar event results in a synchronization of the recipient calendar application to the originating calendar application at least with respect to the approved proposed calendar event.

10. A computer program product comprising computer executable program instructions embodied in a tangible storage medium, the execution of the instructions resulting in operations that comprise:
sending a proposed event from an originating calendar application to a recipient calendar application; and
receiving a reply comprising an approval of the proposed event or a modification to the proposed event from the recipient calendar application.

11. The computer program product of claim 10, where sending the proposed event includes sending an identification associated with the proposed event, and where receiving a reply includes receiving the identification back from the recipient calendar application.

12. The computer program product of claim 10, where the modification to the proposed event comprises at least one of changing a start time, an end time and a date on which the proposed event is to at least one of start or end.

13. The computer program product of claim 10, where at least one of the originating calendar application and the recipient calendar application are resident in a mobile device, and where communication between the originating and recipient calendar applications occurs at least in part through a wireless link.

14. A computer program product comprising computer executable program instructions embodied in a tangible storage medium, the execution of the instructions resulting in operations that comprise:
receiving with a recipient calendar application a proposed event from an originating calendar application; and
sending a reply comprising an approval of the proposed event or a modification to the proposed event to the originating calendar application.

15. The computer program product of claim 14, where receiving the proposed event includes receiving an identification associated with the proposed event, and where sending the reply includes also sending the identification to the originating calendar application, and where the modification to the proposed event comprises at least one of changing a start time, an end time and a date on which the proposed event is to at least one of start or end.

16. The computer program product of claim 14, where at least one of the originating calendar application and the recipient calendar application are resident in a mobile device, and where communication between the originating and recipient calendar applications occurs at least in part through a wireless link.

17. The computer program product of claim 14, further comprising an operation of displaying the received proposed event to a user of the recipient calendar application in a manner that is visually distinct from other displayed calendar events.

18. The computer program product of claim 14, further comprising operations of sorting proposed calendar events and displaying proposed calendar events in isolation from other calendar events.

19. A device comprising a user interface coupled to a first calendar application and configured to send a proposed event to a second calendar application, and further configured to respond to a reply to the proposed event from the second calendar application, where the reply comprises one of an approval of the proposed event or a modification to the proposed event.

20. The device of claim 19, where the proposed event is sent with an identification associated with the proposed event, and where the reply includes the identification.

21. The device of claim 19, where the modification to the proposed event comprises at least one of a modification to a start time, an end time and a date on which the proposed event is to at least one of start or end.

22. The device of claim 19, where in response to receiving a modification to the proposed event, the first calendar application is further configured to consider the received modification to the proposed event as a common proposed event to one of approve the proposed common event or to propose a modification to the common proposed event.

23. The device of claim 19, where said device is a mobile device, and further comprising a communication interface to a wireless link.

24. The device of claim 19, where said device is a mobile communication device, and further comprising a communication interface to one of a short range wireless link and a long range wireless link.

25. The device of claim 19, said user interface and first calendar application configured to display a received proposed calendar event in a manner that is visually distinct from other displayed calendar events.

26. The device of claim 19, said first calendar application further configured to sort proposed calendar events and to display with said user interface the sorted calendar events in isolation from other calendar events.

27. The device of claim 19, where a result of receiving an approval of a proposed calendar event results in a synchronization of the first calendar application to the second calendar application at least with respect to the approved proposed calendar event.

28. The device of claim 19, where said first calendar application is embodied at least in part in an integrated circuit.

29. A device comprising a user interface coupled to a first calendar application and configured to receive a proposed event from a second calendar application, and further configured to send a reply to the proposed event to the second calendar application, where the reply comprises one of an approval of the proposed event or a modification to the proposed event.

30. The device of claim 29, where the proposed event is received with an identification associated with the proposed event, and where the reply includes the identification.

31. The device of claim 29, where the modification to the proposed event comprises at least one of a modification to a start time, an end time and a date on which the proposed event is to at least one of start or end.

32. The device of claim 29, where said device is a mobile device, and further comprising a communication interface to a wireless link.

33. The device of claim 29, where said device is a mobile communication device, and further comprising a communication interface to one of a short range wireless link and a long range wireless link.

34. The device of claim 29, said user interface and first calendar application configured to display a received proposed calendar event in a manner that is visually distinct from other displayed calendar events.

35. The device of claim 29, said first calendar application further configured to sort proposed calendar events and to display with said user interface the sorted calendar events in isolation from other calendar events.

36. The device of claim 29, where a result of sending an approval of a proposed calendar event results in a synchronization of the first calendar application to the second calendar application at least with respect to the approved proposed calendar event.

37. The device of claim 29, where said first calendar application is embodied at least in part in an integrated circuit.
